(19) United States
(12) Patent Application Publication
(10) Pub. No.: US 2021/0060504 A1
(43) Pub. Date: Mar. 4, 2021

(54) Industrial Mixing Machine

(71) Applicant: Dr. Herfeld GmbH & Co. KG, Neuenrade (DE)

(72) Inventor: Wolfgang Rüberg, Menden (DE)

(21) Appl. No.: 17/011,661

(22) Filed: Sep. 3, 2020

(30) Foreign Application Priority Data
Sep. 4, 2019 (DE) 20 2019 104 870.0

(51) Int. Cl. B01F 7/00; B01F 7/16; B01F 7/18

(52) U.S. Cl. CPC B01F 7/00316; B01F 2215/0049; B01F 7/18; B01F 7/1615

(57) ABSTRACT

An industrial mixing machine comprises a mixing head and at least one attachment means for attaching a mixing container, which contains a material to be mixed and is open on the attachment side, to the mixing head to form a closed mixing receptacle. The mixing head is pivotably mounted in relation to a frame as part of a pivotable assembly in such a way that the closed mixing receptacle formed from mixing head and mixing container is pivotable in relation to the frame to carry out the mixing process. The mixing head has at least one mixing tool, which is seated on a drive shaft extending through the mixing head and rotationally driven thereby, having multiple radial blades. The radial blades have a cross-sectional geometry according to which, starting from its maximum thickness, the blade thickness decreases in the rotational direction toward the rear blade end. In the section of decreasing blade thickness, the blade lower side is pitched more strongly with respect to the horizontal in the rotational direction than the blade upper side. An imaginary straight line connecting the rear end of the radial blades to their respective front end facing in the rotational direction is inclined in relation to the horizontal in the same direction as the inclination of the blade lower side in the section of decreasing thickness.

### CROSS-REFERENCE

This application claims priority to German application number DE 20 2019 104 870.0 filed Sep. 4, 2019, which is incorporated by reference herein.

### BACKGROUND

The present disclosure relates to an industrial mixing machine, comprising a mixing head and at least one attachment means for attaching a mixing container, which contains a material to be mixed and is open on the attachment side, to the mixing head for the purpose of forming a closed mixing receptacle, which mixing head is pivotably mounted in relation to a frame as part of a pivotable assembly in such a way that the closed mixing receptacle formed from the mixing head and mixing container is pivotable in relation to the frame to carry out the mixing process, and which mixing head has at least one mixing tool, which is seated on a drive shaft extending through the bottom of the mixing head and rotationally driven thereby, having multiple radial blades, which radial blades have a cross-sectional geometry, according to which the blade thickness decreases in the rotational direction toward the rear blade and starting from its maximum thickness.

In industrial mixers, mixing tools are used which are required for mixing bulk material in particular, typically powdered bulk material, as in, for example, for producing plastic granule mixtures or also in the dye industry. Mixing machines for this purpose have a mixing head pivotable in relation to a frame, which is used at the same time to close a mixing container containing the material to be mixed, which is attached to the mixing head for the purpose of mixing a material to be mixed located therein. After the receptacle has been attached to the mixing head, a closed mixing receptacle is formed from the mixing head and the mixing container containing the material to be mixed. For the purpose of attaching the container to the mixing head, the mixing head has attachment means. This is, inter alia, a circumferential attachment flange protruding outward in the radial direction, on which the complementary attachment flange of the mixing container is brought into contact. For this purpose, for example, screw jacks are used which press the attachment flange of the mixing container against the attachment flange of the mixing head with a seal interposed. Since, in these mixing machines, a mixing container containing the material to be mixed is attached to the mixing head, these mixers are also referred to as container mixers. The mixing head itself has a concavely curved bottom side, which merges into a circumferential cylindrical wall that extends concentrically to the center axis of the mixing head and supports the attachment flange on its free end. The mixing head supports at least one mixing tool, the drive shaft of which is guided through the bottom of the mixing head.

The mixing head itself is pivotably arranged in relation to the machine frame of the mixing machine so that the mixing takes place in an inverted position in relation to the mixing head, in which the mixing head is arranged at the bottom and the mixing container attached thereon is arranged at the top. This inverted position is required so that the material to be mixed contained in the mixing container comes into contact with the at least one mixing tool supported by the mixing head. The rotationally driven mixing tool is used to produce a flow of material to be mixed inside the closed mixing chamber. Such an industrial mixer is known, for example, from EP 0 225 495 A 2.

A mixing tool as described above is known from DE 20 2016 107 397 U 1. The radial blades of the mixing tool known from this document have a cross-sectional geometry which corresponds to the cross-sectional geometry of the wing of an aircraft. The cross-sectional geometry of the radial blades is shaped like a wing and has a convex upper side having curvature that essentially decreases to the rear in the rotational direction and a lower side, which merges from a convexly curved front section in the rotational direction into a concavely curved rear section. The front side facing in the rotational direction is convexly curved. Using this mixing tool, good quality mixing is possible with low temperature introduction and low performance decrease. In addition, wall and bottom deposits are reduced. At the radial outer ends thereof, the radial blades can support outer blades, which have a wedge-shaped cross-sectional geometry, wherein the thickness of the outer blades decreases opposite to the rotational direction. The wing-shaped cross-sectional geometry of the radial blades is supposed to be responsible for the good mixing at relatively low running speed. Due to the special cross-sectional geometry of the radial blades, the production thereof is relatively complex, which drives up the costs of such a bladed mixing tool.

The foregoing examples of the related art and limitations therewith are intended to be illustrative, not exclusive. Other limitations will become apparent to those skilled in the art upon a reading of the specification and a study of the drawings.

### SUMMARY

The following embodiments and aspects thereof are described and depicted in conjunction with systems, tools and methods which are meant to be illustrative, not limiting in scope. In various embodiments, one or more problems have been reduced or eliminated, while other embodiments are directed to other improvements.

Proceeding from this background, an aspect of the present disclosure is to refine a mixing machine having a mixing tool with multiple radial blades of the above-described type, in such a way that not only is good mixing capability provided at low running power and bottom and wall accumulations in the mixing head and on the walls of the mixing container, respectively, are reduced, but further its mixing tool may also be produced more cost-effectively. In addition, it would be desirable if the mixing result could moreover be improved using the mixing tool to reduce the required mixing time in this way.

This is achieved by a mixing machine of the type mentioned at the outset, wherein, in the section of decreasing blade thickness, the blade lower side is pitched more strongly with respect to the horizontal in the rotational direction than the wing upper side and wherein an imaginary straight line connecting the rear end of the radial blade to its respective front end is inclined in relation to the horizontal in the same direction as the inclination of the blade lower side in the section of decreasing thickness.

An improved mixing result can surprisingly be achieved in a mixing machine having such a mixing tool, despite the simpler geometry of the cross sections of its radial blades in comparison to previously known mixing tools of this type. The radial blades of the mixing tool are pitched more strongly with their blade lower side in relation to a horizontal than the blade upper sides, specifically in the section of decreasing blade thickness. The horizontal in the context of these statements is a straight line in a plane which extends perpendicularly to the rotational axis of the mixing tool. The blade lower side is inclined facing in the rotational direction. This means that an imaginary extension of the blade lower side in the rotational direction extends toward the mixing container bottom. Furthermore, the radial blades are designed over their entire extension in the rotational direction (their cross-sectional width) in such a way that an imaginary straight line connecting the rear section to the respective front section is inclined in the same direction as the inclination of the blade lower side in the section of decreasing thickness. Therefore, the front end of such a radial blade, when projected in a common vertical plane with the rear blade end, is located at a lower vertical level than the rear blade end. The radial blades taper starting from their maximum thickness toward the rear blade end. The maximum thickness in the radial blade cross section is preferably located spaced apart from the front end of the radial blade facing in the rotational direction.

According to one design of such a mixing tool, the blade upper side of the radial blade is inclined in the same direction as the blade lower side. In such a mixing tool, the blade upper side as a whole, and therefore also in its section between the maximum blade thickness and the rear blade end, is used to give particles of material to be mixed contacting the blade upper side an upwardly oriented moment due to the rotation of the radial blades. Such a cross-sectional geometry may be formed using straight blade surfaces, the adjoining edges of which may be rounded. If such an additional upward moment acting on the material to be mixed is not to be introduced, the radial blades can also be designed having a horizontal blade upper side starting from its maximum thickness toward the rear blade end.

A radial blade has a particularly simple radial blade cross-sectional geometry which is embodied as mirror symmetrical with respect to its cross section in relation to the plane in which the straight line connecting the rear end to the front end lies. The special spatial orientation of the radial blades with its inclination also ensures with such a geometrically simple cross-sectional design that an upwardly oriented moment acting on the material to be mixed particles is exerted on the blade lower side.

It was surprising to find that an outstanding mixing result is achieved using such a relatively simple cross-sectional geometry of the radial blades, which differs from a typical blade profile, due to the particular alignment thereof in relation to the movement thereof through the material to be mixed. This is not insignificantly attributed to the blade lower side inclined in relation to horizontal, whereby the space below the blade lower side enlarges toward the rotational shadow. It was possible to observe particularly effective turbulence during the mixing process in this section below the blade and behind such a radial blade.

At least in the section of decreasing blade thickness, according to one embodiment, the blade lower sides of the radial blades are embodied as straight or flat from their maximum thickness toward the rear blade end. In a further design, more or less the entire blade lower side is embodied as straight or flat, i.e., from the front to the rear blade end. The blade upper side may also be embodied as straight or flat at least in the section of decreasing thickness. Only the region of maximum thickness is typically embodied as rounded, as is the blade front side facing in the rotational direction.

Preferably, the inclination of the imaginary straight line between the rear and the front blade ends is inclined at most at the angle in relation to the horizontal at which the blade lower side is inclined in relation to the horizontal in the section of decreasing thickness toward the rear blade end. In such a design, the blade lower side does not have any depressions, such as concave sections, which simplifies its producibility.

The front side of the radial blades can be embodied as rounded, for example, having a constant curvature radius. Of course, the radius can also be nonconstant. In general, the radius between the end of such a radial blade facing in the rotational direction toward the blade upper side will then be designed having a larger radius than the part of the rounding which connects the front end of the radial blade to the blade lower side. It is also entirely possible to design the front end of such a radial blade as an edge, preferably rounded, specifically by bringing the blade upper side together with the blade lower side.

An improvement of the mixing effect and also a further reduction of wall accumulations can be achieved if the radial blades each support an outer blade at their end. This preferably has the same cross-sectional geometry as the radial blades. With such a design of the outer blades, they are arranged with respect to their cross-sectional geometry such that the blade side, which is the lower side in the radial blades, is the blade side facing outward in the radial direction in the outer blades. The outer blade sides of the outer blades are preferably pitched in relation to a cylindrical lateral surface enveloping the outer blade sides in the same way as the blade lower side in relation to a horizontal. The pitch angle of the blade outer sides in relation to the enveloping cylindrical lateral surface can be the same as the pitch angle of the blade lower sides in relation to a horizontal. The pitch angle of the blade outer sides in relation to the enveloping cylindrical lateral surface can also differ, however, from the pitch of the blade lower side in relation to a horizontal, for example, it can be a few degrees smaller.

In addition to aspects and embodiments described above, further aspects and embodiments will become apparent by reference to the appended drawings, wherein like reference numerals generally designate corresponding structures in the several views.

### BRIEF DESCRIPTION OF THE DRAWINGS

The present disclosure is described hereinafter on the basis of an example embodiments with reference to the appended figures, wherein:

FIG. 1 shows a perspective view of an industrial mixing machine;

FIG. 2 shows a view of the lower side of the head plate of the mixing head with a mixing tool supported thereon;

FIG. 3 shows a perspective view of the mixing tool alone;

FIG. 4 shows a side view of the mixing tool of FIG. 3, attached to the drive shaft extending through the head plate of the mixing head;

FIG. 5 shows an enlarged illustration of the cross-sectional geometry of the radial blades of the mixing tool of FIGS. 3 and 4;

FIG. 6 shows a view of the head plate of the mixing head corresponding to FIG. 2 with another mixing tool placed on the drive shaft; and

FIG. 7 shows a side view corresponding to FIG. 4 of the mixing tool of FIG. 6 seated on the drive shaft.

Before explaining the depicted embodiments, it is to be understood that the invention is not limited in application to the details of the particular arrangements shown, since the invention is capable of other embodiments. The embodiments and figures disclosed herein are to be considered illustrative rather than limiting.

### DETAILED DESCRIPTION

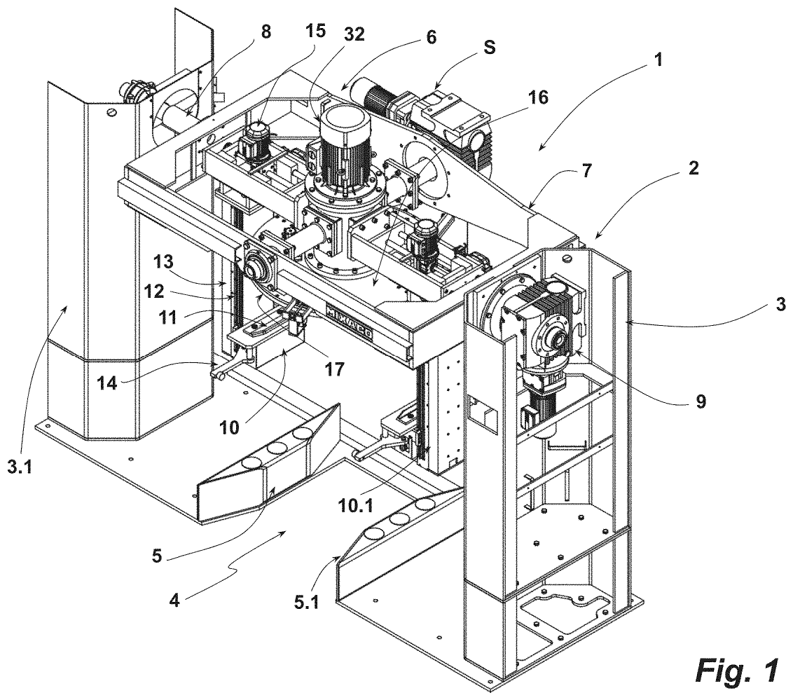

Referring to FIG. 1, a mixing machine 1 is used for the industrial mixing of material located in a mixing container, for example, plastic granules. The mixing machine 1 has a frame 2, which is provided in the illustrated embodiment by two stands 3, 3.1. A container entrance 4 is located between the stands 3, 3.1 in the area of the bottom. The container entrance 4 is delimited laterally in the direction of each of the stands 3, 3.1 by a respective side wall 5, 5.1. In their upper section, the two stands 3, 3.1 are connected to one another via a pivotable assembly 6. The pivotable assembly 6 comprises a frame component 7, on each of whose two narrow sides a pivot shaft 8 is fastened. The pivot shaft 8 is mounted in the stands 3, 3.1. An electromotive drive 9, via which the pivotable assembly 6 can be pivoted around the axis of its pivot shaft 8, is located in the stand 3.

Two lifting devices 10, 10.1 designed as jackscrews are part of the pivotable assembly 6. The lifting devices 10, 10.1 are constructed identically. The basic structure of the lifting device 10 is described below. These statements apply similarly to the lifting device 10.1. The lifting device 10 has a lifting plate 11 as part of a lifting plate unit movable in the vertical direction by a spindle 12. A further plate, which has a chamfer towards the container flange, is located on the lifting plate. The container is thus centered during the lifting. The lifting plate unit is guided on a guide 13. The spindle 12 is driven by an electric motor. The lifting plate unit can be adjusted in the vertical direction by means of the spindle 12. It is shown in its lowermost position in FIG. 1. A locking lever 14, which can be pivoted around a vertical pivot axis from its base position shown in FIG. 1 in the direction of the mixing container receptacle, is furthermore part of the lifting plate unit. The pivoting of the locking lever 14 is used to lock a mixing container moved into the container entrance 4. The locking lever 4 acts against the outer wall of such a mixing container. The lifting device 10 is movable by means of an electric motor 15 as part of the pivotable assembly 6 in the direction of the longitudinal extension of the pivot axis of the pivotable assembly 6. The electric motor 15 drives a spindle drive for this purpose.

The pivotable assembly furthermore comprises a mixing head, of which its upper side (outer side) can be seen in FIG. 1.

The mixing head 16 having the two lifting devices 10, 10.1 is gimbal-mounted within the frame component 7. By means of a pivot drive S, the mixing head 16 with its two lifting devices 10, 10.1 can be pivoted about a rotational axis extending transversely to the pivot axis of the frame component 7. As a result, the mixing head 16 can be pivoted around two axes perpendicular to one another during operation of the mixing machine 1. This permits a mixing process to be carried out in which a mixing container attached to the mixing head 16 executes a multidimensional pendulum movement.

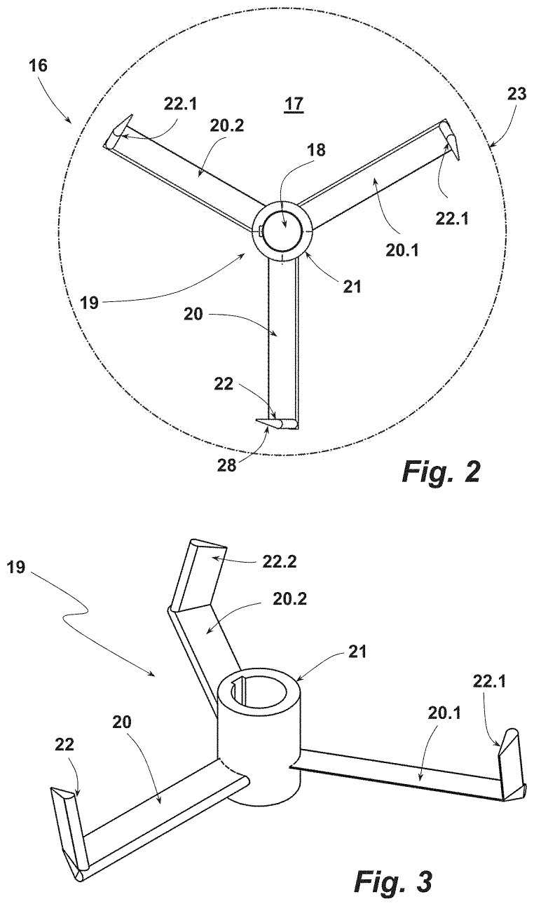

Part of the mixing head 16 is a head plate 17 forming a bottom of the rotated mixing receptacle in closing the mixing container interior. A drive shaft 18 extends through the head plate 17 and is driven by an electric motor 32 (see also FIG. 2). A mixing tool 19 is seated on the drive shaft 18 at a distance to the upper side of the head plate 17 forming the bottom of the closed mixing receptacle when rotated. The mixing tool 19 is a bladed tool with three radial blades 20, 20.1, 20.2. The radial blades 20, 20.1, 20.2 are attached to the hub 21 of the mixing tool 19 at the same angular distance from one another. The radial blades 20, 20.1, 20.2 are all constructed identically. Each radial blade 20, 20.1, 20.2 has an outer blade 22, 22.1, 22.2 on its radial outer end, each attached to the blade upper side. The attachment of the outer blades 22, 22.1, 22.2 is shown schematically in the figures. In practice, the radial blade will be embodied continuously having a slight radius between the two blade sections.

FIG. 2 shows the inner lateral surface 23 of a mixing container, which is attached to the mixing head 16 and is otherwise not shown in greater detail. It is used to visualize the radial outer distance of the outer blades 22, 22.1, 22.2 from the inside of a mixing container represented by the lateral surface.

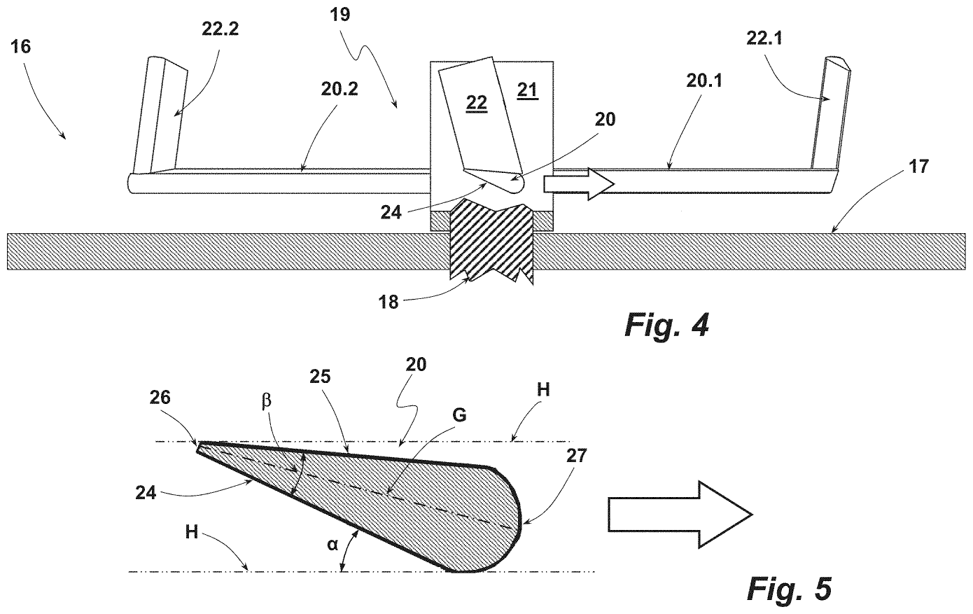

FIG. 3 shows the mixing tool 19 alone in a perspective view. The cross-sectional geometry of the radial blades 20, 20.1, 20.2 is already clear from this illustration. This is explained below with reference to FIGS. 4 and 5 on the basis of the radial blade 20. The radial blade 20—the same applies to the two other radial blades 20.1, 20.2—has a wedge-shaped cross-sectional geometry facing opposite to the rotational direction with a rounded end face facing in the rotational direction. The rotational direction of the mixing tool 19 is indicated in these figures by a block arrow.

FIG. 5 shows the cross-sectional profile of the radial blade 20 in an enlarged view, without the outer blade 22 formed on the end thereof. The radial blade 20 is pitched in relation to a horizontal H, specifically with an inclination direction in the direction toward the head plate 17 of the mixing head 16 in the rotational direction. In the illustration, it is in the horizontal plane. This plane is also, independently of the current spatial orientation of the head plate, the plane which is spanned perpendicularly to the rotational axis of the mixing tool 19. In the spatial orientation of the cross-sectional geometry of the radial blade 20 shown in the figures, the straight blade lower side 24, which is thus embodied without additional contours, encloses an angle α of approximately 25° with the horizontal H. The blade upper side 25 is also embodied to be straight and in the illustrated embodiment is inclined in the same direction as the blade lower side 24, but only by a few degrees. The inclination of the blade upper side 25 is also apparent on the radial blade 20.2 in the illustration of FIG. 4 of the mixing tool 19, in which view the radial blade 20.2 is shown from its front side and, in this perspective, the blade upper side rising due to its inclination is visible. The straight sections of the blade lower side 24 and the blade upper side 25 represent the section of the radial blade 20, the thickness of which decreases from its maximum thickness in the direction toward the rear blade end 26.

Due to the described pitch, the rear end of the radial blade 20 provided by the blade end 26 is at a higher level in relation to a vertical than the front end of the straight section of the blade upper side 25 facing in the rotational direction. The blade lower side 24 and blade upper side 25, which are embodied as straight without additional contours, are brought together at the blade end 26 due to their different inclination. The blade lower side 24 encloses an angle β of approximately 20° with the blade upper side 25. Facing in the rotational direction, the front face 27 of the radial blade 20 is embodied as rounded, with a constant radius of curvature in the illustrated embodiment. It is essential in the design of the cross-sectional geometry of the radial blade 20 that a straight line G connecting the blade end 26 to the front blade end facing in the rotational direction is inclined in the same direction as the inclination of the blade lower side 24. In the illustrated embodiment, the inclination of this straight line G, at approximately 12°, is less by approximately half than the inclination of the blade lower side 24 in relation to the horizontal H. The radial blade 20 is constructed mirror symmetrically with respect to the plane in which the straight line G is located. The plane in which the straight line G is located is the central longitudinal plane of the radial blade 20.

During a rotation of the mixing tool 19 in the rotational direction shown in the figures, material to be mixed incident on the curved front face 27 above its apex is guided in the vertical direction upward to the blade upper side 25. As a result, the material to be mixed receives an upwardly oriented moment in the vertical direction, which is assisted by the pitch of the blade upper side 25 inclined in the rotational direction. Due to this, the material to be mixed through which the radial blade 20 is moved is raised upward in the vertical direction in the manner of a shovel or accelerated away from the radial blade 26. At the same time, material to be mixed located below its apex facing in the rotational direction is moved due to the rounded front face 27 in the vertical direction to the head plate 17. However, the pitch of the blade lower side 24, against the background of the material to be mixed displaced by the radial blade 20, causes a certain negative pressure in the space below the radial blade, which enlarges toward the blade end 26, due to which material to be mixed located below the blade lower side 24 of the radial blade 20 is pulled upward and engaged by the following radial blade 20.2 and receives a further moment conveying the material to be mixed particles upward in the vertical direction via its blade upper side. This special mode of operation is the reason for the intensive mixing of material to be mixed using the mixing tool 19.

The outer blade 22 on the radial blade 20 shows the same cross-sectional geometry as the radial blade 20 and the same blade pitch in relation to the lateral surface 23 of a mixing container. As is apparent from the top view of FIG. 2, the blade side 28 facing outward in the radial direction is also pitched in relation to the lateral surface 23 like the blade lower side 24 in relation to the horizontal H. The pitch angle of the blade side 28 of the outer blade 22 with the lateral surface 23 is a few degrees smaller in the illustrated embodiment than the pitch angle α of the blade lower side 24 in relation to the horizontal H.

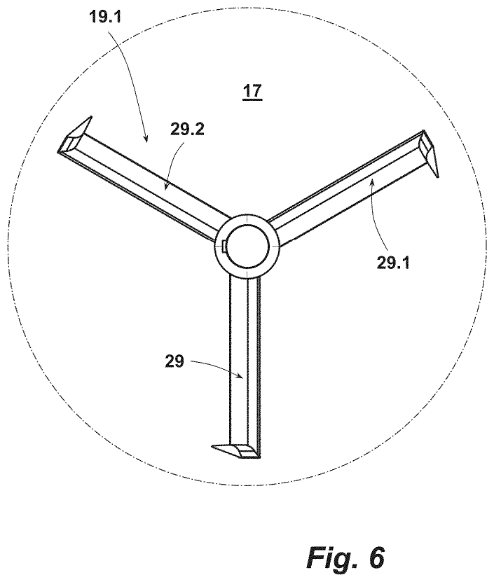

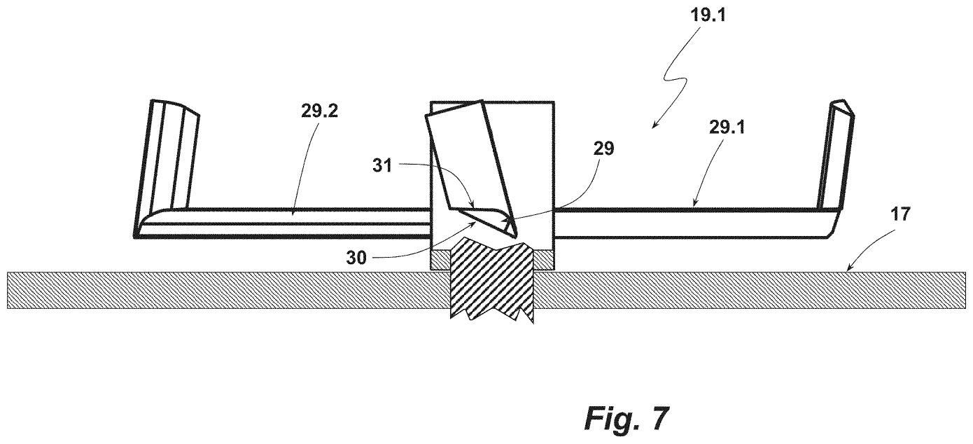

FIG. 6 shows a further mixing tool 19.1, which is basically constructed like the mixing tool 19 of the preceding figures. The mixing tool 19.1 differs in the specific cross-sectional geometry of its radial blades 29, 29.1, 29.2 from that of the mixing tool 19. The cross-sectional geometry of these radial blades 29, 29.1, 29.2 can be seen more clearly in the side view of the mixing tool 19.1 in FIG. 7. The cross-sectional geometry of the radial blade 29—this also applies to the two other radial blades 29.1, 29.2—differs from that of the radial blade 20 in that the blade lower side 30 is embodied as straight as a whole and the blade lower side 30 thus corresponds to the imaginary straight line which connects the blade end to the front end. The blade upper side 31 has a straight rear section, by which the section of decreasing thickness is defined starting from the maximum thickness of the radial blade 29. This radial blade 29 has its greatest thickness (distance from blade lower side 30 ) to the blade upper side 31 set back somewhat further from its front end in relation to the radial blade 20. At this point, the blade upper side 31 is embodied as rounded to form an apex and guided on the front side to the blade lower side 30 to form an edge.

During a rotation of the mixing tool 19.1, material to be mixed is exclusively conveyed upward and thus away from the head plate 17 by the radial blade 29. In this mixing tool 19.1, during operation more material to be mixed, which is not engaged by the radial blade 29 and is located below its movement path in the direction to the head plate 17, is swirled up, since no components of material to be mixed are displaced by the radial blade 29 in the direction toward the head plate 17, in contrast to the radial blade 20.

The invention has been described on the basis of example embodiments. Without leaving the scope of the appended claims, persons skilled in the art will recognize further options, modifications, permutations, additions, combinations and sub-combinations for implementing the invention, without having to explain them in greater detail herein. The appended claims should therefore be interpreted to include all such options, modifications, permutations, additions, combinations and sub-combinations. Each embodiment described herein has numerous equivalents. Terms and expressions herein are used as terms and expressions of description and not of limitation, and there is no intention in the use thereof to exclude any equivalents of the features shown or described, or portions thereof.

LIST OF REFERENCE SIGNS

| | |
|---|---|
| 1 | mixing machine |
| 2 | frame |
| 3, 3.1 | stand |
| 4 | container entry |
| 5, 5.1 | side wall |
| 6 | pivotable assembly |
| 7 | frame component |
| 8 | pivot axis |
| 9 | drive unit |
| 10, 10.1 | lifting device |
| 11 | lifting plate |
| 12 | spindle |
| 13 | guide |
| 14 | locking lever |
| 15 | electric motor |
| 16 | mixing head |
| 17 | head plate |
| 18 | drive shaft |
| 19 | mixing tool |
| 20, 20.1, 20.2 | radial blade |
| 21 | hub |
| 22, 22.1, 22.2 | outer blade |
| 23 | lateral surface |
| 24 | blade lower side |
| 25 | blade upper side |
| 26 | blade end |
| 27 | front face |
| 28 | blade side |
| 29, 29.1, 29.2 | radial blade |
| 30 | blade lower side |
| 31 | blade upper side |
| 32 | electric motor |
| G | straight line |
| H | horizontal |
| S | pivot drive |
| α | angle |
| β | angle |

1. An industrial mixing machine, comprising:
a mixing container for containing a material to be mixed, the mixing container open on an attachment side;
a mixing head which attaches to the attachment side of the mixing container to form a closed mixing receptacle, the mixing head pivotably mounted in relation to a frame such that the mixing receptacle formed from mixing head and mixing container is pivotable in relation to the frame for carrying out a mixing process;
wherein the mixing head has at least one mixing tool which is seated on a drive shaft engaging through a bottom of the mixing head and rotationally driven thereby, the mixing tool comprising multiple radial blades, each blade having a cross-sectional geometry according to which a blade thickness decreases through a section of the blade in a rotational direction toward a rear end of the blade starting from its maximum thickness;
wherein, in the section of decreasing blade thickness, a lower side of the blade is pitched more strongly in the rotational direction with respect to the horizontal than an upper side of the blade, and an imaginary straight line connecting the rear end of the blade to a respective front end of the blade facing in the rotational direction is inclined in relation to the horizontal in the same direction as the inclination of the lower side of blade in the section of decreasing blade thickness.

2. The mixing machine of claim 1, wherein, at least in the section of decreasing blade thickness, the lower side of the blade is embodied as a flat surface.

3. The mixing machine of claim 2, wherein the entire lower side of the blade is embodied as a flat surface at least substantially.

4. The mixing machine of claim 1, wherein, in the section of decreasing blade surface, the upper side of the blade is embodied as a flat surface at least substantially.

5. The mixing machine of claim 1, wherein the radial blades are embodied mirror symmetrically to the imaginary straight line in cross-section.

6. The mixing machine of claim 1, wherein the inclination of the imaginary straight line between the respective rear end and the respective front end of the radial blade is inclined at an angle relative to the horizontal which is equal to or less than that at which the lower side of the blade is inclined in relation to the horizontal in the section of decreasing blade thickness.

7. The mixing machine of claim 1, wherein the front sides of the radial blades facing in the rotational direction are rounded.

8. The mixing machine of claim 7, wherein the front sides of the radial blades are rounded with a constant radius of curvature.

9. The mixing machine of claim 8, wherein the radial blades have their maximum thickness in a section of the rounded front sides.

10. The mixing machine of claim 1, wherein the front end of the radial blade facing in the rotational direction is formed by an edge guiding together the upper side of the blade with the lower side of the blade.

11. The mixing machine of claim 1, wherein the mixing tool has three radial blades.

12. The mixing machine of claim 1, wherein the outer ends of the radial blades each support an outer blade provided on the upper side of the blade.

13. The mixing machine of claim 12, wherein a front end of each outer blade extending away from the upper side of the radial blade is inclined opposite to the rotational direction of the mixing tool.

14. The mixing machine of claim 13, wherein a cross-sectional geometry of the outer blades corresponds to the cross-sectional geometry of the radial blades, wherein an outer blade side of each outer blade, which faces outward in a radial direction in the outer blades, corresponds to the lower side of the radial blades, and said outer blade side of the outer blades is pitched in relation to a cylindrical lateral surface in the same manner as the lower sides of the radial blades in relation to a horizontal.

15. The mixing machine of claim 14, wherein a pitch angle of the outer blade sides of the outer blades in relation to the cylindrical lateral surface is less than that at which the lower sides of the radial blades are pitched in relation to a horizontal.

16. The mixing machine of claim 12, wherein a cross-sectional geometry of the outer blades corresponds to the cross-sectional geometry of the radial blades, wherein an outer blade side of each outer blade, which faces outward in a radial direction in the outer blades, corresponds to the lower side of the radial blades, and said outer blade side of the outer blades is pitched in relation to a cylindrical lateral surface in the same manner as the lower sides of the radial blades in relation to a horizontal.

17. The mixing machine of claim 16, wherein a pitch angle of the outer blade sides of the outer blades in relation to the cylindrical lateral surface is less than that at which the lower sides of the radial blades are pitched in relation to a horizontal.
